(19) United States
(12) Patent Application Publication
(10) Pub. No.: US 2009/0083094 A1
(43) Pub. Date: Mar. 26, 2009

(54) RENEWAL METHOD AND SYSTEM

(76) Inventors: Michael Randy May, Johnson City, NY (US); Gautam Majumdar, Wappingers Falls, NY (US); Muthusamy Palanisamy Muthusamy, Novi, MI (US); Sachin Popli, New Delhi (IN)

Correspondence Address: SCHMEISER, OLSEN & WATTS, 22 CENTURY HILL DRIVE, SUITE 302, LATHAM, NY, 12110, US

(21) Appl. No.: 11/861,436

(22) Filed: Sep. 26, 2007

(51) Int. Cl. G06F 17/50

(52) U.S. Cl. 705/7

(57) ABSTRACT

A renewal method and system. The method includes receiving, by a computing system from a requester, a selection of said first candidate from a list of candidates. The computing system retrieves a portion of candidate related data from an original request document for the candidate. The computing system receives from the requester, a selection of at least a one supplier from a list of suppliers. The computing system generates a first renewal request document associated with the first candidate. The first renewal request document includes the portion of the candidate related data from the original request document. The first renewal request document is for first renewing an association between a first company and the first candidate. The computing system transmits the first renewal request document to the at least one supplier.

### FIELD OF THE INVENTION

The present invention relates to a method and associated system for renewing services for contracted employees.

### BACKGROUND OF THE INVENTION

Rehiring individuals within an organization typically requires a process that may be complicated and inaccurate. Accordingly, there exists a need in the art to overcome the deficiencies and limitations described herein above.

### SUMMARY OF THE INVENTION

The present invention provides a renewal method comprising:

receiving, by a computing system from a requester, a command for enabling a first renewal process associated with a company, said computing system comprising a memory device, said memory device comprising an original request document for at least one candidate, a list of candidates, and a request/skills details template, said list of candidates comprising said at least one candidate;

presenting, by said computing system, said first list of candidates to said requester;

receiving, by said computing system from said requester, a first selection of said at least one candidate of said list of candidates;

receiving, by said computing system from said requester, first verification data verifying that said at least one candidate is associated with said first renewal process;

generating, by said computing system, a first renewal request number for identifying a first renewal request document;

retrieving, by said computing system, a portion of candidate related data from said original request document;

placing, by said computing system, said portion of said candidate related data in said request/skills details template;

receiving, by said computing system from said requester, first input data associated with said at least one candidate;

placing, by said computing system, said first input data in said request/skills details template;

presenting, by said computing system, said request/skills details template comprising said portion of said candidate related data and said first input data;

receiving, by said computing system from said requester, first validation data verifying that said portion of said candidate related data from said original request document in said request/skills details template comprises first current data associated with said at least one candidate and said first renewal process;

receiving from said requester, by said computing system, a selection of a first supplier;

generating, by said computing system, a first renewal request document associated with said at least one candidate, said first renewal request document comprising said portion of said candidate related data from said original request document and said first input data, said first renewal request document for first renewing an association between said company and said at least one; and

transmitting, by said computing system, said first renewal request document to said first supplier.

The present invention provides a computing system comprising a processor coupled to a computer-readable memory unit, said memory unit comprising an original request document for at least one candidate, a list of candidates, and a request/skills details template, and instructions that when executed by the processor implement a renewal method, said list of candidates comprising said at least one candidate, said method comprising:

receiving, by a computing system from a requester, a command for enabling a first renewal process associated with a company;

presenting, by said computing system, said first list of candidates to said requester;

receiving, by said computing system from said requester, a first selection of said at least one candidate of said list of candidates;

receiving, by said computing system from said requester, first verification data verifying that said at least one candidate is associated with said first renewal process;

generating, by said computing system, a first renewal request number for identifying a first renewal request document;

retrieving, by said computing system, a portion of candidate related data from said original request document;

placing, by said computing system, said portion of said candidate related data in said request/skills details template;

receiving, by said computing system from said requester, first input data associated with said at least one candidate;

placing, by said computing system, said first input data in said request/skills details template;

presenting, by said computing system, said request/skills details template comprising said portion of said candidate related data and said first input data;

receiving, by said computing system from said requester, first validation data verifying that said portion of said candidate related data from said original request document in said request/skills details template comprises first current data associated with said at least one candidate and said first renewal process;

receiving from said requester, by said computing system, a selection of a first supplier;

generating, by said computing system, a first renewal request document associated with said at least one candidate, said first renewal request document comprising said portion of said candidate related data from said original request document and said first input data, said first renewal request document for first renewing an association between said company and said at least one; and

transmitting, by said computing system, said first renewal request document to said first supplier.

The present invention provides a computer program product, comprising a computer usable medium comprising an original request document for at least one candidate, a list of candidates, and a request/skills details template, and a computer readable program code embodied therein, said list of candidates comprising said at least one candidate, said computer readable program code adapted to implement a renewal method within a computing system, said method comprising:

receiving, by a computing system from a requester, a command for enabling a first renewal process associated with a company;

presenting, by said computing system, said first list of candidates to said requester;

receiving, by said computing system from said requester, a first selection of said at least one candidate of said list of candidates;

receiving, by said computing system from said requester, first verification data verifying that said at least one candidate is associated with said first renewal process;

generating, by said computing system, a first renewal request number for identifying a first renewal request document;

retrieving, by said computing system, a portion of candidate related data from said original request document;

placing, by said computing system, said portion of said candidate related data in said request/skills details template;

receiving, by said computing system from said requester, first input data associated with said at least one candidate;

placing, by said computing system, said first input data in said request/skills details template;

presenting, by said computing system, said request/skills details template comprising said portion of said candidate related data and said first input data;

receiving, by said computing system from said requester, first validation data verifying that said portion of said candidate related data from said original request document in said request/skills details template comprises first current data associated with said at least one candidate and said first renewal process;

receiving from said requester, by said computing system, a selection of a first supplier;

generating, by said computing system, a first renewal request document associated with said at least one candidate, said first renewal request document comprising said portion of said candidate related data from said original request document and said first input data, said first renewal request document for first renewing an association between said company and said at least one; and

transmitting, by said computing system, said first renewal request document to said first supplier.

The present invention provides a process for supporting computer infrastructure, said process comprising providing at least one support service for at least one of creating, integrating, hosting, maintaining, and deploying computer-readable code in a computing system comprising a memory unit, said memory unit comprising an original request document for at least one candidate, a list of candidates, and a request/skills details template, and a computer readable program code embodied therein, said list of candidates comprising said at least one candidate, said computer readable program code adapted to implement a renewal method within a computing system, said method comprising:

receiving, by a computing system from a requester, a command for enabling a first renewal process associated with a company;

presenting, by said computing system, said first list of candidates to said requester;

receiving, by said computing system from said requester, a first selection of said at least one candidate of said list of candidates;

receiving, by said computing system from said requester, first verification data verifying that said at least one candidate is associated with said first renewal process;

generating, by said computing system, a first renewal request number for identifying a first renewal request document;

retrieving, by said computing system, a portion of candidate related data from said original request document;

placing, by said computing system, said portion of said candidate related data in said request/skills details template;

receiving, by said computing system from said requester, first input data associated with said at least one candidate;

placing, by said computing system, said first input data in said request/skills details template;

presenting, by said computing system, said request/skills details template comprising said portion of said candidate related data and said first input data;

receiving, by said computing system from said requester, first validation data verifying that said portion of said candidate related data from said original request document in said request/skills details template comprises first current data associated with said at least one candidate and said first renewal process;

receiving from said requester, by said computing system, a selection of a first supplier;

generating, by said computing system, a first renewal request document associated with said at least one candidate, said first renewal request document comprising said portion of said candidate related data from said original request document and said first input data, said first renewal request document for first renewing an association between said company and said at least one; and

transmitting, by said computing system, said first renewal request document to said first supplier.

The present invention advantageously provides a method and associated system capable of performing a process for rehiring individuals within an organization

### BRIEF DESCRIPTION OF THE DRAWINGS

FIG. 1 illustrates a block diagram of a system for renewing hired services of a sub-contracted candidate, in accordance with embodiments of the present invention.

FIG. 2 illustrates a flowchart describing an algorithm used by the system of FIG. 1 for renewing hired services of a sub-contracted candidate, in accordance with embodiments of the present invention.

FIG. 3 illustrates an example of a first computer screen shot associated with a step of the algorithm of FIG. 2, in accordance with embodiments of the present invention.

FIG. 4 illustrates an example of a second computer screen shot section, in accordance with embodiments of the present invention.

FIG. 5A illustrates a first portion of a third computer screen shot, in accordance with embodiments of the present invention.

FIG. 5B illustrates a second portion of the third computer screen shot, in accordance with embodiments of the present invention FIG. 5C illustrates a third portion of the third computer screen shot, in accordance with embodiments of the present invention.

FIG. 6 illustrates a computer system used for renewing hired services of a sub-contracted candidate, in accordance with embodiments of the present invention.

### DETAILED DESCRIPTION OF THE INVENTION

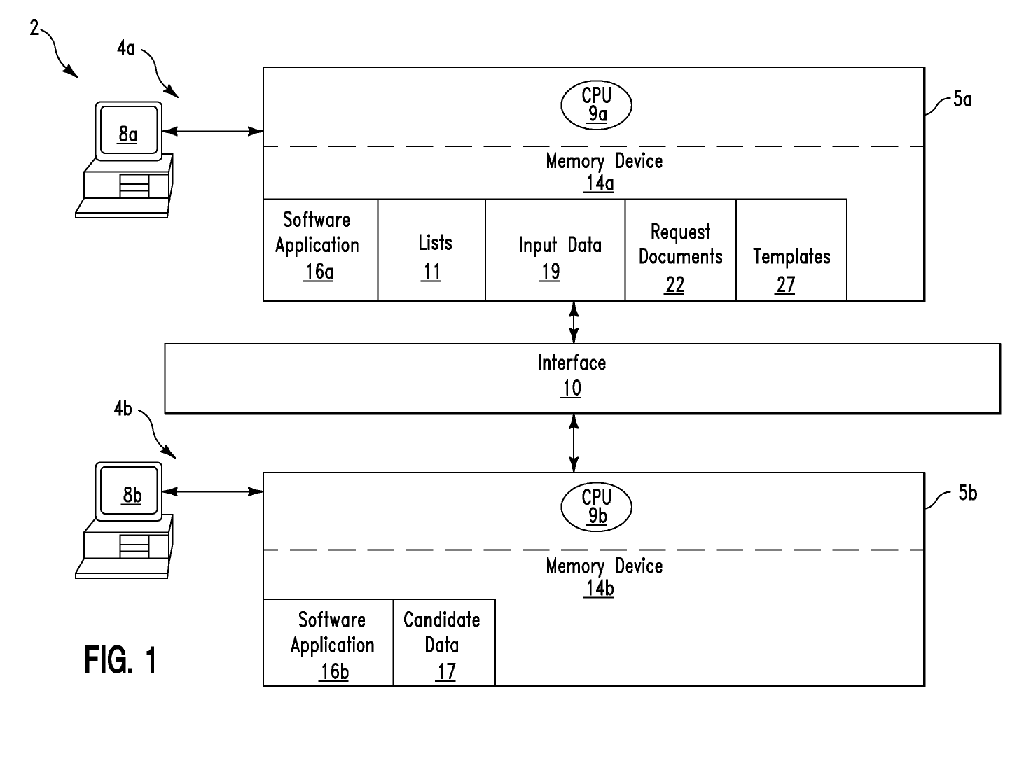

FIG. 1 illustrates a block diagram of a system 2 for renewing hired services of a sub-contracted candidate, in accordance with embodiments of the present invention. Renewing hired services of a sub-contracted candidate (i.e., a renewal process) comprises renewing services of a sub-contracted candidate (i.e., a person/people with a specific skill(s) already working for a supplier at a requesting company), such that the candidate's skills/services (i.e., job duties) may be hired for extended period (i.e., extended from original services). A company would use the renewal process (i.e., to generate a renewal request document) when an existing services end date for the candidate is approaching and a contracted service of the candidate requires an extension. The renewal process performed in system 2 may be used as follows:
1. Allowing a requester to search for a candidate(s) to be renewed and carry forward details from previous request document to new request document. The renewal process comprises validating data to be carried forward from a previous or original request document to new request document.
2. Generating multiple renewal request documents (i.e., multiple renewal cycles) for a candidate(s).
3. A new request number, a new line item number, and new candidate description may be generated with each renewal cycle.
4. A renewal request document is generated only if the most current details of the candidate request document have been fulfilled in the system. This ensures that complete authorized candidate details are only used when creating new request. With the completion of each renewal cycle, the information under the new renewal request is considered to be the most current information of previous renewal request. The information under this most current renewal request would be used for a next renewal cycle (i.e. information under this new renewal request would be forwarded to a next renewal cycle).
5. Candidate(s) may have their services renewed several times.
6. Multiple candidates under a renewal request may be selected and renewed together. Alternatively, a single candidate under a renewal request may be selected and renewed independently.
7. Configuration of a renewal request may be based on a country.
8. Complete renewal history details for a candidate(s) may be viewed by the requester.
9. A renewal request may be transmitted to an originally configured core (original) supplier or a new non-core supplier (new).

A requester is defined herein as a person/people (e.g., users from an entity such as, inter alia, a company) looking to renew a candidate(s) or resource (i.e., a person/people with a specific skill(s)) to fill a job position. A supplier is defined herein as an external entity or company (e.g., an employment agency) that actually employs the candidate(s). An original request document is defined herein as an original request under which candidate services were originally hired for a first time by a requesting organization. This is an original request from which a renewal of a candidate(s) is initiated for a first time. A renewal request document is defined herein as new request document for renewing services for a sub-contracted candidate(s) (i.e., a person/people with a specific skill(s) already working for a supplier at a requesting company), such that the candidate's skills/services (i.e., job duties) may be hired for extended period (i.e., extended from a original services). The renewal request document is generated using data from the original request document or a current renewal request document. System 2 comprises a computing system 4a (e.g., a server) connected to a computing system 4b (e.g., a server) through an interface 10. Interface 10 may comprise any type of interface known to a person of ordinary skill in the art including, inter alia, a local area network, (LAN), a wide area network (WAN), the Internet, etc. Computing system 4a comprises a computing apparatus 5a and an interface terminal 8a. Computing system 4b comprises a computing apparatus 5b and an interface terminal 8b. Computing apparatus 5a comprises a CPU 9a and a memory device 14a. Alternatively, memory device 14a may be located external to computing apparatus 5a. Memory device 14a comprises a software application 16a, lists 11, input data 19, request documents 22, and templates 27. Lists 11 and input data 19 may be inputted into computing apparatus 5a through interface terminal 8a. Computing apparatus 5b comprises a CPU 9b and a memory device 14b. Alternatively, memory device 14b may be located external to computing apparatus 5b. Candidate data 17 (i.e., comprising lists of candidates and responses from the suppliers) may be inputted into computing apparatus 5b through interface terminal 8b.

The requester interacts with software application 16a to issue a command for enabling a renewal process (i.e., to generate a renewal request document) for renewing services of a sub-contracted candidate(s) (i.e., a person/people with a specific skill(s) already working for a supplier at a requesting company), such that the candidate's skills/services (i.e., job duties) may be hired for extended period (i.e., extended from original services). Software application 16a presents a list (i.e., from lists 11) of candidates (i.e., through interface terminal 8a) for the requester and the requester selects a candidate(s) for renewal. Upon selecting the candidate for renewal, software application 16a generates a renewal request identification number for identifying a renewal request document. Software application 16a retrieves data from the original request document (i.e., of request document 22) or a previous renewal request document (i.e., of request document 22). The retrieved data may include any data associated with the candidate (e.g., skills related data, services date related data, job title data, etc). The retrieved data is automatically placed or entered into a request template (e.g., from templates 27). The request template (e.g., a request/skills details template) comprises questions or fields associated with the candidate(s). The request template comprises general questions or fields related to, inter alia, a project name, location for placing a candidate comprising the requested skills, project coordinators, the requesting company and department, accounting information, time frames (i.e., for hiring candidates), skill levels, status levels, etc. The requester may additionally input data (e.g., input data 19) into the request template. After all of the retrieved data and input data has been entered software application 16a and/or the requester validates whether the retrieved data is the most current data associated with the candidate(s) (i.e., retrieved from the previous request document). After the validation process, software application 16a generates a renewal request document and transmits the renewal request document to a supplier (i.e., a core supplier or a non-core supplier) in order to renew services of the sub-contracted candidate. When a request document is routed to a supplier, the supplier (i.e., using software application 16b and candidate data 17) will submit candidates using the most recent negotiated rates configured at a time of submission.

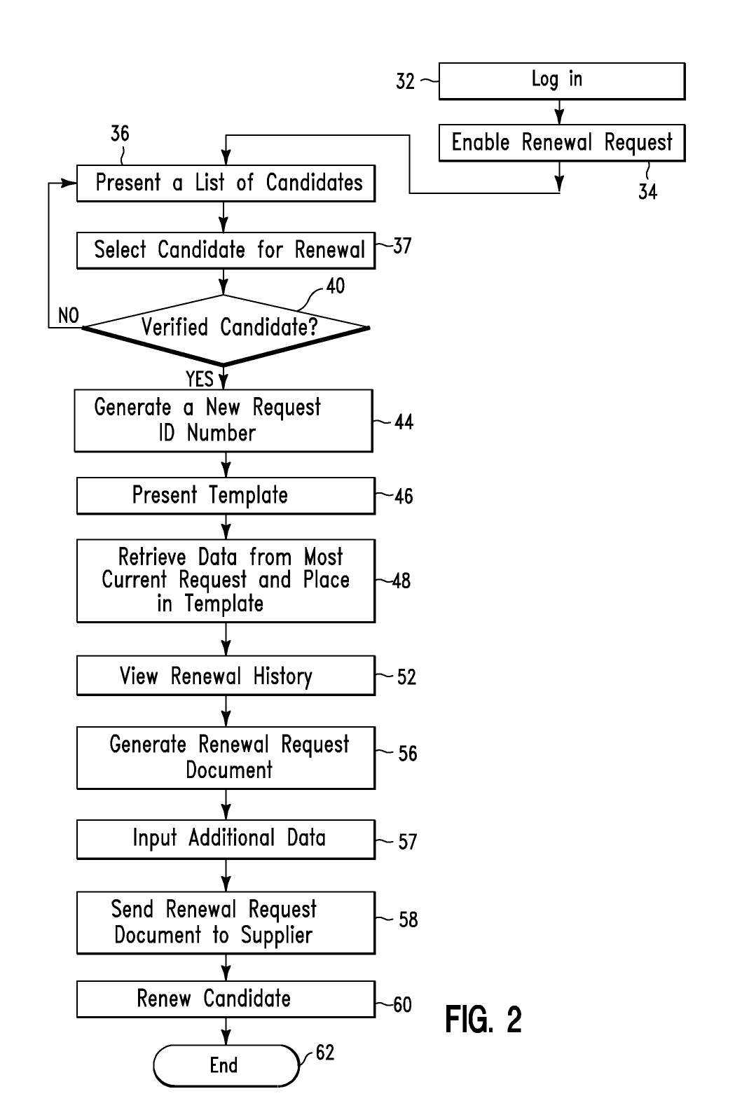

FIG. 2 illustrates a flowchart describing an algorithm used by system 2 of FIG. 1 for renewing hired services of a sub-contracted candidate. In step 32, a requester logs into the computing system (e.g., computing system 4a of FIG. 1). In step 34, the requester enables a renewal request. For example, the requester may navigate to a request type selection screen on interface terminal 8a and select a request type of “Renewal based on existing request”. In step 36, the requester is presented with a list of candidates. In step 37, a candidate(s) is selected for renewal. In step 40, a manual verification process verifies if the selected candidate is the desired candidate to be renewed. The manual verification process is performed for each candidate individually.

If in step 40, the verification process verifies that the selected candidate is not the desired candidate to be renewed, then step 36 is repeated.

If in step 40, the verification process verifies that the selected candidate is the desired candidate to be renewed, then in step 44, a new request ID number and a new line item number is/are generated. In step 46, a request template is presented to the requester. In step 48, the most current details (i.e., data) with respect to the selected candidate from a most current request document (i.e., an original request document or a renewal request document) are automatically retrieved (i.e., by software application 16a) and placed into associated sections of the request template. In step 52, the requester may view a renewal history of the candidate. In step 56, a renewal request document is generated. In step 57, the requester may add additional data/details to the renewal request document. In step 58, the renewal request document is transmitted to a supplier at currently negotiated terms and conditions and not at rates on which candidate was hired previously. The supplier may respond to the renewal request with the candidate(s). Alternatively, the supplier may choose not to respond to the renewal request because the supplier may want more money than currently negotiated terms and conditions will supply. Additionally, it is possible that an original core supplier was not configured at a time of this auto-renewal process cycle. In this case system 2 would only present a non-core supplier selection to the requester. The requester would add in any non-core supplier details with no negotiated existing rates. The non-core selection also allows the requester to take advantage of any newly negotiated lower rates for the skill. In step 60, candidate services are renewed for the selected candidate. In step 62, the process is terminated. The process described in the algorithm of FIG. 2 may be repeated in order to generate new renewal request documents for the candidate(s) each time services expire.

An example for implementation of software application 16a for renewing hired services of a sub-contracted candidate is described as follows:

Table 1 illustrates a table used to maintain a candidate history of the renewal process.

TABLE 1

SrvReq_Id: CHAR(6) (FK)
SrvReqIt_Num: CHAR(3) (FK)
Supp_InstAppl_Id: CHAR(12) (FK)
Supp_Id: CHAR(17) (FK)
Cand_Num: CHAR(3) (FK)
OrigSrvReq_Id: CHAR(6) (FK)
OrigSrvReqIt_Num: CHAR(3) (FK)
OrigSupp_InstAppl_Id: CHAR(12) (FK)
OrigSupp_Id: CHAR(17) (FK)
OrigCand_Num: CHAR(3) (FK)
PrevSrvReq_Id: CHAR(6)
PrevSrvReqIt_Num: CHAR(3) (FK)
PrevSupp_InstAppl_Id: CHAR(12) (FK)
PrevSupp_Id: CHAR(17) (FK)
PrevCand_Num: CHAR(3) (FK)
Row Prog Updt Id: CHAR(12) (FK)
Row Status Cd: CHAR(1)
Row Update Time: TIMESTAMP
Row LastUpd UserId: VARCHAR(80)
Row Create Time: TIMESTAMP
Row Create User Id: VARCHAR(80)

In table 1, a candidate is identified with a combination of 5 rows (i.e. SrvReq_Id, SrvReqIt_Num, Supp_Id, Supp_InstAppl_Id and Cand_Num). The combination of these 5 rows will be referred to as a “Candidate key”. The rows with prefix as “Orig” comprises the candidate key corresponding to the candidate from where the renewal process of the Candidate started the very first time. This key will act as common link to track a renewal history of the candidate. This is the first request from where a renewal of the Candidate started. The rows with a prefix of “Prev” comprises the candidate key corresponding to a previous candidate from which the current candidate was renewed. For example, a candidate comprises a candidate key of SrvReq_Id=S111, SrvReqIt_Num=002, Supp_Id=12345, Supp_instApp_Id=ABCSAPM0 and Cand_Num=003. The candidate status is FULF (i.e., After the candidate has gone thru entire process of candidate selection and authorization, the status of candidate changes to fulfilled once it is finally submitted to the purchasing order application). The candidate must be renewed although the candidate has never been renewed. Upon renewal, new values for SrvReq_Id, SrvReqIt_Num, Cand_Num would be generated and values of Supp_Id and Supp_InstAppl_Id from a previous request# would be used. The rows with prefix as “Row” comprises updated candidate entries. This would result in following entries to be made in table 2.

TABLE 2

| Column Name | Value |
|---|---|
| SrvReq_Id | S222 |
| SrvReqIt_Num | 001 |
| Supp_Id | 12345 |
| Supp_InstAppl_Id | ABCSAPM0 |
| Cand_Num | 001 |
| OrigSrvReq_Id | S111 |
| OrigSrvReqIt_Num | 002 |
| OrigSupp_Id | 12345 |
| OrigSupp_InstAppl_Id | ABCSAPM0 |
| OrigCand_Num | 003 |
| PrevSrvReq_Id | S111 |
| PrevSrvReqIt_Num | 002 |
| PrevSupp_Id | 12345 |
| PrevSupp_InstAppl_Id | ABCSAPM0 |
| PrevCand_Num | 001 |

In table 2, Cand_Num=001 under SrvReqIt_Num=001 of SrvReq_Id=S222 was renewed from OrigCand_Num=003 under OrigSrvReqIt_Num=002 of OrigSrvReq_Id=S111. The values of Supp_Id and Supp_InstAppl_Id remain the same at a time of renewal, but may be changed at a later time. The “Prev” pre-fixed rows will have the same values as that of “Orig” pre-fixed rows at this time of renewal, but may be changed at a later time. The “Prev” pre-fixed rows may be changed at a later time if the following scenarios occur:
1. An original core supplier is not configured at a time of renewal.
2. A same person must to be rehired through another supplier in which case the requester makes a selection of non-core supplier.

When Cand_Num=001 under SrvReqIt_Num=001 of SrvReq_Id=S222 is renewed, it creates a new candidate Cand_Num=001 under SrvReqIt_Num=001 of SrvReq_Id=S333. An entry would be made in memory device 14a of FIG. 1 as illustrated in table 3 below.

TABLE 3

| Column | Value |
|---|---|
| SrvReq_Id | S333 |
| SrvReqIt_Num | 001 |
| Supp_Id | 12345 |
| Supp_InstAppl_Id | ABCSAPM0 |
| Cand_Num | 001 |
| OrigSrvReq_Id | S111 |
| OrigSrvReqIt_Num | 002 |
| OrigSupp_Id | 12345 |
| OrigSupp_InstAppl_Id | ABCSAPM0 |
| OrigCand_Num | 003 |
| PrevSrvReq_Id | S222 |
| PrevSrvReqIt_Num | 001 |
| PrevSupp_Id | 12345 |
| PreySupp_InstAppl_Id | ABCSAPM0 |
| PrevCand_Num | 001 |

In table 3, the values of “Orig” pre-fixed rows for new record inserted in table 2 are similar to the values of“Orig” pre-fixed rows of S222. The values of “Prev” pre-fixed rows correspond to PrevSrvReq_Id=S222, PrevSrvReqIt_Num=001, PrevSupp_Id=12345, PrevSupp_InstAppl_Id=ABCSAPM0, PrevCand_Num=001.

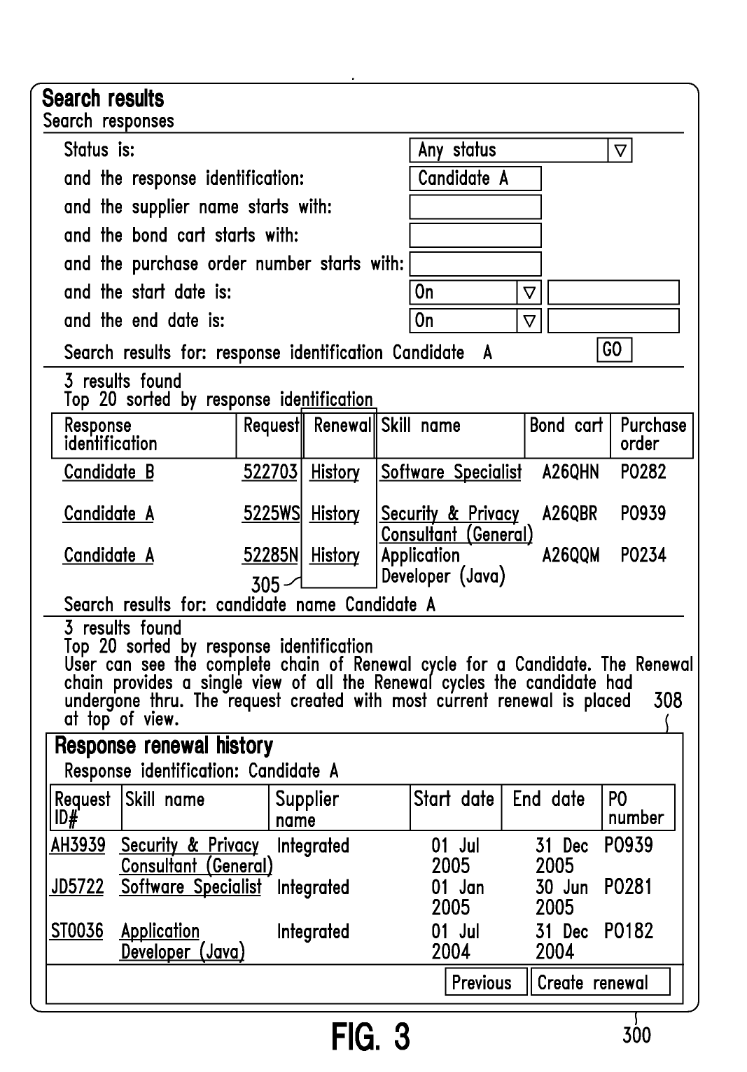

FIG. 3 illustrates an example of a computer screen shot 300 (e.g., displayed on interface terminal 8a of FIG. 1) associated with step 52 of FIG. 2, in accordance with embodiments of the present invention. In FIG. 3, the computing system displays (e.g., displayed on interface terminal 8a of FIG. 1) a renewal history associated with a candidate(s). For candidate(s) which have under gone at least one renewal cycle, a history link 305 is displayed in the candidate search results. The requester may view a complete chain of renewal cycles for a candidate(s) in section 308. The renewal request document generated with a most current renewal is placed at a top of the view.

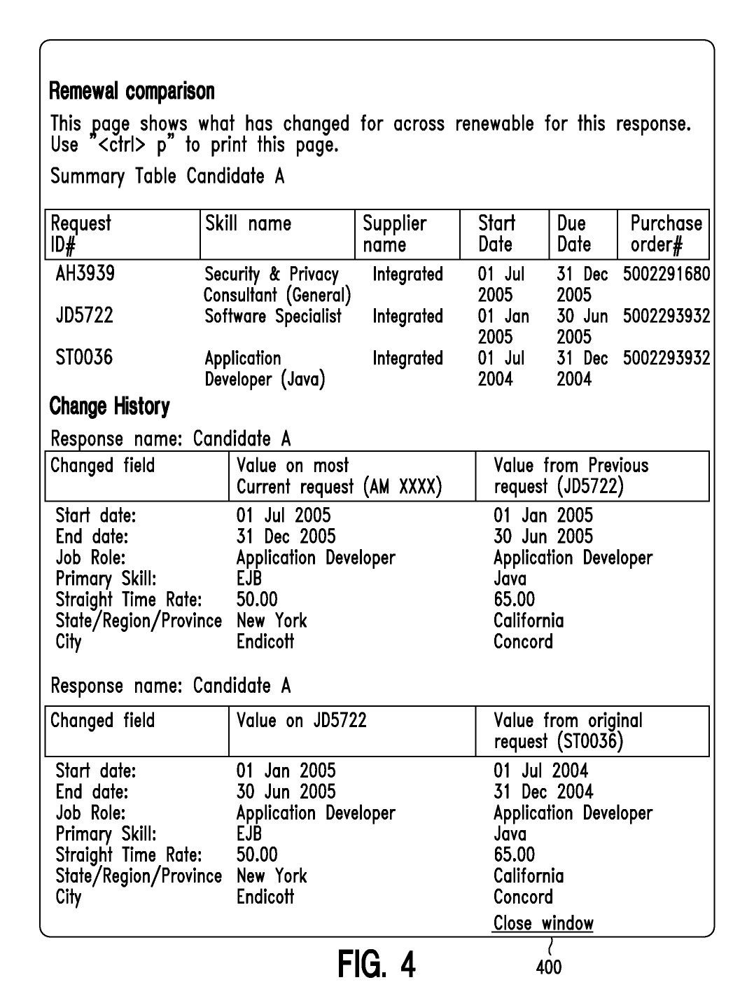

FIG. 4 illustrates an example of a computer screen shot section 400 (e.g., displayed on interface terminal 8a of FIG. 1), in accordance with embodiments of the present invention. In FIG. 4, the computing system displays a renewal change log at a candidate (i.e., candidate A) level. The requester may view a renewal history change log 400. Renewal history change log 400 provides a single view for comparison of changes between various renewal cycles. There are pre-identified sets of fields which are displayed in Renewal history change log 400. Renewal history change log 400 may be viewed at single candidate level or for all candidates under the request that underwent renewal process cycle.

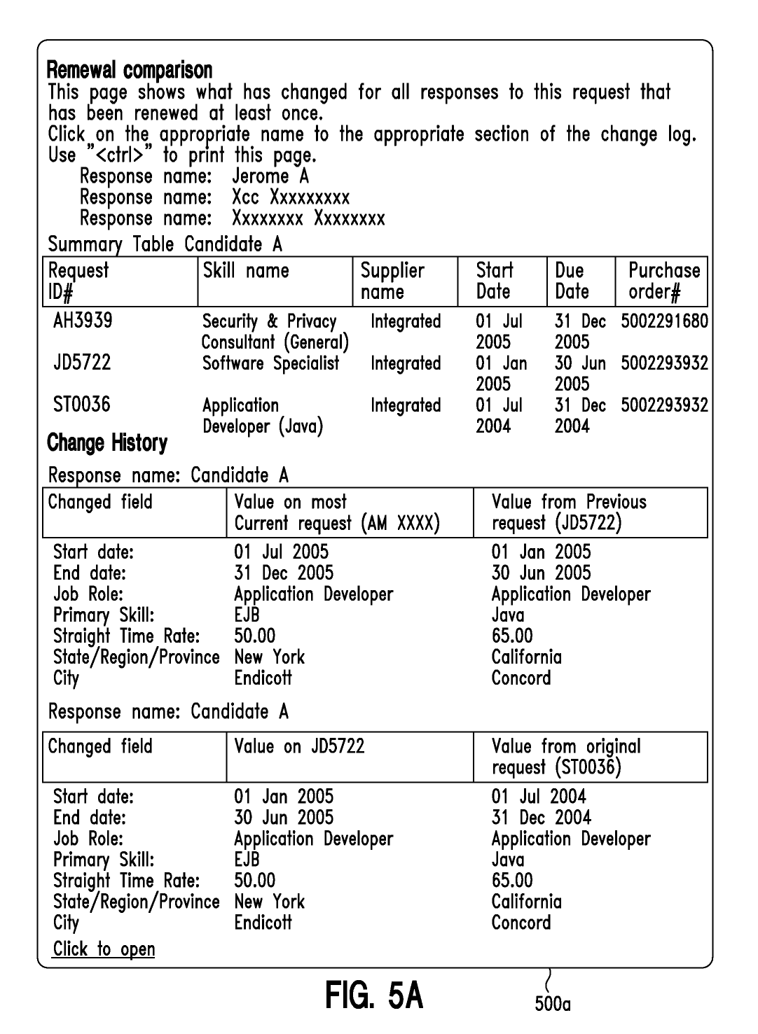

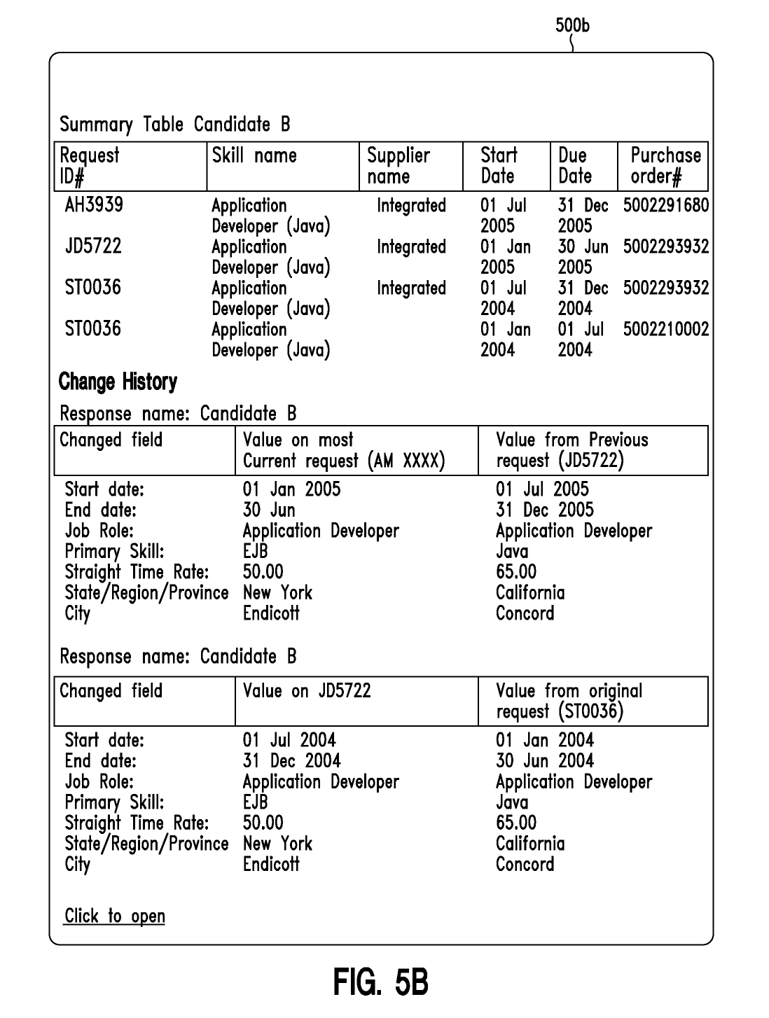

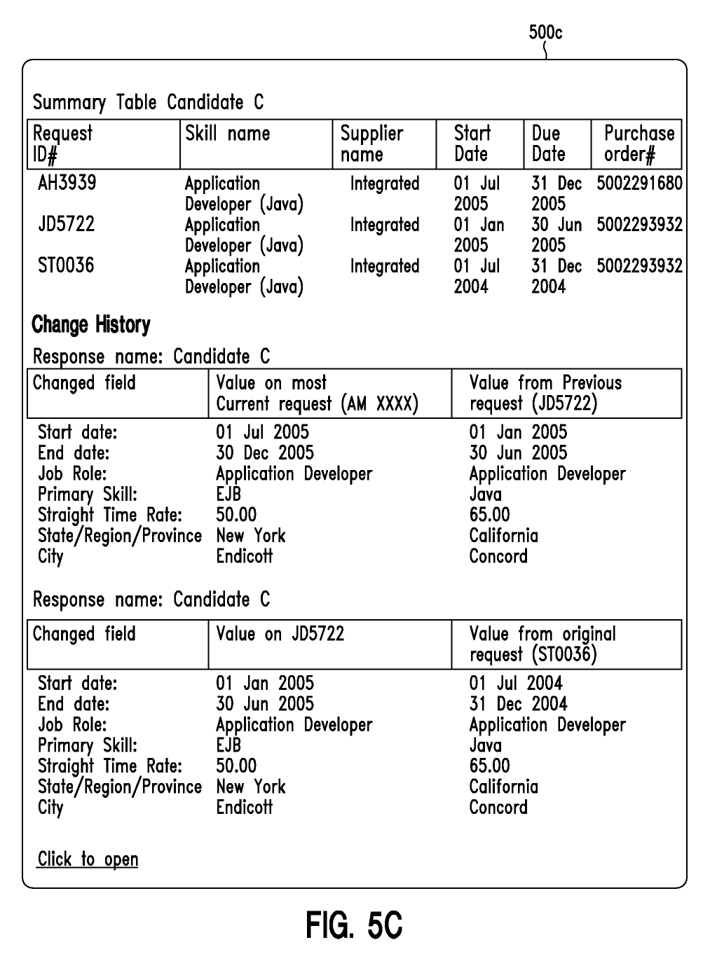

FIGS. 5A-5C illustrates potions 500a, 500b, and 500c of a computer screen shot 500, in accordance with embodiments of the present invention. FIGS. 5A-5C list a Renewal history of the candidates, such that the most a current candidate information in the renewal chain is at a top of the list, followed by a next current candidate. A change history section displays a comparison of values for some pre-identified fields for a candidate in between various renewal cycles. There is one table each for displaying a comparison in values of certain pre-identified fields between two consecutive requests of renewal chain starting with a display of field comparison between the most current request and the previous request that participated in the renewal cycle, followed by a table of comparison between the previous request and the request preceding the previous request. This process continues until the table of comparison between the original request and original request +1. The table column header of the last renewal cycle is illustrated as “Value on most current request <request#>” and “Value from previous request <request#>”. The table column header of (last−1) renewal cycle is illustrated as “Value on <request#>” and “value from previous request <request#>”. The table column header of the first renewal cycle is illustrated as “Value on <request#>” and “value from original request <request#>”.

FIG. 5A illustrates portion 500a of computer screen shot 500, in accordance with embodiments of the present invention. Portion 500a illustrates a renewal history change log for candidate A at a request level.

FIG. 5B illustrates portion 500b of computer screen shot 500, in accordance with embodiments of the present invention. Portion 500b illustrates a renewal history change log for candidate B at a request level.

FIG. 5C illustrates portion 500c of computer screen shot 500, in accordance with embodiments of the present invention. Portion 500c illustrates a renewal history change log for candidate C at a request level.

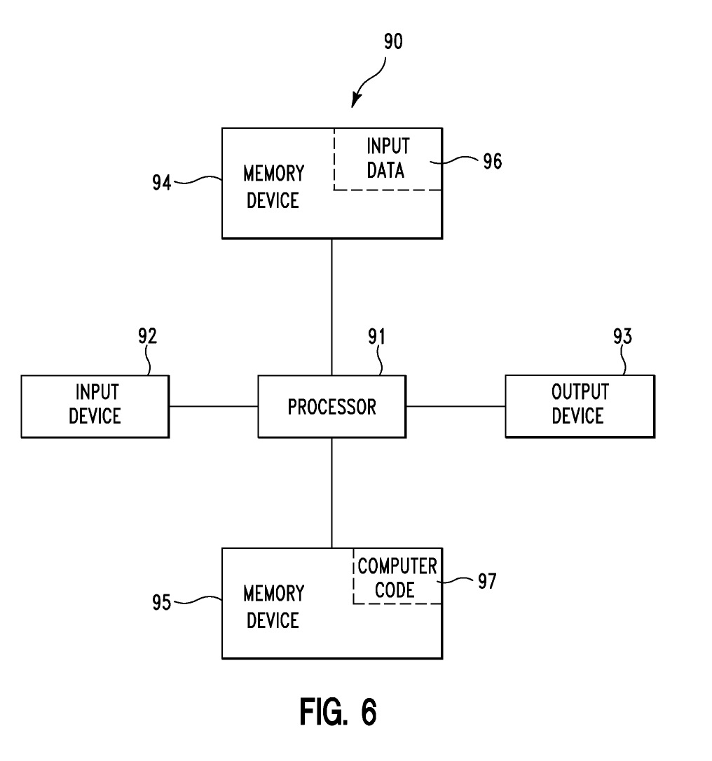

FIG. 6 illustrates a computer system 90 (i.e., computing system 4a and/or 4b in FIG. 1) used for renewing hired services of a sub-contracted candidate, in accordance with embodiments of the present invention. The computer system 90 comprises a processor 91, an input device 92 coupled to the processor 91, an output device 93 coupled to the processor 91, and memory devices 94 and 95 each coupled to the processor 91. The input device 92 may be, inter alia, a keyboard, a mouse, etc. The output device 93 may be, inter alia, a printer, a plotter, a computer screen, a magnetic tape, a removable hard disk, a floppy disk, etc. The memory devices 94 and 95 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 95 includes a computer code 97. The computer code 97 includes algorithms (e.g., algorithm of FIG. 2) for renewing hired services of a sub-contracted candidate. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices not shown in FIG. 5) may comprise the algorithm of FIG. 2 and may be used as a computer usable medium (or a computer readable medium or a program storage device) having a computer readable program code embodied therein and/or having other data stored therein, wherein the computer readable program code comprises the computer code 97. Generally, a computer program product (or, alternatively, an article of manufacture) of the computer system 90 may comprise said computer usable medium (or said program storage device).

Still yet, any of the components of the present invention could be deployed, managed, serviced, etc. by a service provider who offers to renew hired services of a sub-contracted candidate. Thus the present invention discloses a process for deploying or integrating computing infrastructure, comprising integrating computer-readable code into the computer system 90, wherein the code in combination with the computer system 90 is capable of performing a method for renewing hired services of a sub-contracted candidate. In another embodiment, the invention provides a business method that performs the process steps of the invention on a subscription, advertising, and/or fee basis. That is, a service provider, such as a Solution Integrator, could offer to renew hired services of a sub-contracted candidate. In this case, the service provider can create, maintain, support, etc., a computer infrastructure that performs the process steps of the invention for one or more customers. In return, the service provider can receive payment from the customer(s) under a subscription and/or fee agreement and/or the service provider can receive payment from the sale of advertising content to one or more third parties.

While FIG. 6 shows the computer system 90 as a particular configuration of hardware and software, any configuration of hardware and software, as would be known to a person of ordinary skill in the art, may be utilized for the purposes stated supra in conjunction with the particular computer system 90 of FIG. 6. For example, the memory devices 94 and 95 may be portions of a single memory device rather than separate memory devices.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A renewal method comprising:
receiving, by a computing system from a requester, a command for enabling a first renewal process associated with a company, said computing system comprising a memory device, said memory device comprising an original request document for at least one candidate, a list of candidates, and a request/skills details template, said list of candidates comprising said at least one candidate;
presenting, by said computing system, said first list of candidates to said requester;
receiving, by said computing system from said requester, a first selection of said at least one candidate of said list of candidates;
receiving, by said computing system from said requester, first verification data verifying that said at least one candidate is associated with said first renewal process;
generating, by said computing system, a first renewal request number for identifying a first renewal request document;
retrieving, by said computing system, a portion of candidate related data from said original request document;
placing, by said computing system, said portion of said candidate related data in said request/skills details template;
receiving, by said computing system from said requester, first input data associated with said at least one candidate;
placing, by said computing system, said first input data in said request/skills details template;
presenting, by said computing system, said request/skills details template comprising said portion of said candidate related data and said first input data;
receiving, by said computing system from said requester, first validation data verifying that said portion of said candidate related data from said original request document in said request/skills details template comprises first current data associated with said at least one candidate and said first renewal process;
receiving from said requester, by said computing system, a selection of a first supplier;
generating, by said computing system, a first renewal request document associated with said at least one candidate, said first renewal request document comprising said portion of said candidate related data from said original request document and said first input data, said first renewal request document for first renewing an association between said company and said at least one; and
transmitting, by said computing system, said first renewal request document to said first supplier.

2. The method of claim 1, further comprising:
configuring, by said computing system, said first renewal request document based on a country.

3. The method of claim 1, further comprising:
presenting, by said computing system for said requester, all of said candidate related data for review.

4. The method of claim 1, wherein said first supplier is comprises a supplier selected from the group consisting of an original core supplier associated with said original request document and a non-core supplier.

5. The method of claim 1, wherein said original request document comprises candidate skill selections for said at least one candidate, and wherein said first renewal request document comprises said first candidate skill selection for said first candidate.

6. The method of claim 1, wherein said original request document comprises a first candidate skill selection for said at least one candidate, wherein said first renewal request document comprises a second candidate skill selection for said at least one candidate, and wherein said first candidate skill selection comprises a different candidate skill than said second candidate skill selection.

7. The method of claim 1, further comprising:
storing, within said memory device, said first renewal request document;
receiving, by said computing system from said requester, a command for enabling a second renewal process associated with said company and said at least one candidate;
presenting, by said computing system, said first list of candidates to said requester;
receiving, by said computing system from said requester, a second selection of said at least one candidate of said list of candidates;
receiving, by said computing system from said requester, second verification data verifying that said at least one candidate is associated with said second renewal process;
generating, by said computing system, a second renewal request number for identifying a second renewal request document;
retrieving, by said computing system, a portion of candidate related data from said first renewal request document;
placing, by said computing system, said portion of said candidate related data from said first renewal request document in said request/skills details template;
receiving, by said computing system from said requester, second input data associated with said at least one candidate;
placing, by said computing system, said second input data in said request/skills details template;
presenting, by said computing system, said request/skills details template comprising said portion of said candidate related data from said first renewal request document and said second input data;
receiving, by said computing system from said requester, second validation data verifying that said portion of said candidate related data from said first renewal request document in said request/skills details template comprises second current data associated with said at least one candidate and said second renewal process;
receiving from said requester, by said computing system, a selection of said first supplier from said list of suppliers;
generating, by said computing system, a second renewal request document associated with said at least one candidate, said second renewal request document comprising said portion of said candidate related data from said first renewal request document and said second input data, said second renewal request document for second renewing an association between said company and said at least one candidate; and
transmitting, by said computing system, said second renewal request document to said first supplier.

8. A computing system comprising a processor coupled to a computer-readable memory unit, said memory unit comprising an original request document for at least one candidate, a list of candidates, and a request/skills details template, and instructions that when executed by the processor implement a renewal method, said list of candidates comprising said at least one candidate, said method comprising:
receiving, by a computing system from a requester, a command for enabling a first renewal process associated with a company;
presenting, by said computing system, said first list of candidates to said requester;
receiving, by said computing system from said requester, a first selection of said at least one candidate of said list of candidates;
receiving, by said computing system from said requester, first verification data verifying that said at least one candidate is associated with said first renewal process;
generating, by said computing system, a first renewal request number for identifying a first renewal request document;
retrieving, by said computing system, a portion of candidate related data from said original request document;
placing, by said computing system, said portion of said candidate related data in said request/skills details template;
receiving, by said computing system from said requester, first input data associated with said at least one candidate;
placing, by said computing system, said first input data in said request/skills details template;
presenting, by said computing system, said request/skills details template comprising said portion of said candidate related data and said first input data;
receiving, by said computing system from said requester, first validation data verifying that said portion of said candidate related data from said original request document in said request/skills details template comprises first current data associated with said at least one candidate and said first renewal process;
receiving from said requester, by said computing system, a selection of a first supplier;
generating, by said computing system, a first renewal request document associated with said at least one candidate, said first renewal request document comprising said portion of said candidate related data from said original request document and said first input data, said first renewal request document for first renewing an association between said company and said at least one; and
transmitting, by said computing system, said first renewal request document to said first supplier.

9. The computing system of claim 8, wherein said method further comprises:
configuring, by said computing system, said first renewal request document based on a country.

10. The computing system of claim 8, wherein said method further comprises:
presenting, by said computing system for said requester, all of said candidate related data for review.

11. The computing system of claim 8, wherein said first supplier is comprises a supplier selected from the group consisting of an original core supplier associated with said original request document and a non-core supplier.

12. The computing system of claim 8, wherein said original request document comprises candidate skill selections for said at least one candidate, and wherein said first renewal request document comprises said first candidate skill selection for said first candidate.

13. The computing system of claim 8, wherein said original request document comprises a first candidate skill selection for said at least one candidate, wherein said first renewal request document comprises a second candidate skill selection for said at least one candidate, and wherein said first candidate skill selection comprises a different candidate skill than said second candidate skill selection.

14. The computing system of claim 8, wherein said method further comprises:
storing, within said memory unit, said first renewal request document;
receiving, by said computing system from said requester, a command for enabling a second renewal process associated with said company and said at least one candidate;
presenting, by said computing system, said first list of candidates to said requester;
receiving, by said computing system from said requester, a second selection of said at least one candidate of said list of candidates;
receiving, by said computing system from said requester, second verification data verifying that said at least one candidate is associated with said second renewal process;
generating, by said computing system, a second renewal request number for identifying a second renewal request document;
retrieving, by said computing system, a portion of candidate related data from said first renewal request document;
placing, by said computing system, said portion of said candidate related data from said first renewal request document in said request/skills details template;
receiving, by said computing system from said requester, second input data associated with said at least one candidate;
placing, by said computing system, said second input data in said request/skills details template;
presenting, by said computing system, said request/skills details template comprising said portion of said candidate related data from said first renewal request document and said second input data;
receiving, by said computing system from said requester, second validation data verifying that said portion of said candidate related data from said first renewal request document in said request/skills details template comprises second current data associated with said at least one candidate and said second renewal process;
receiving from said requester, by said computing system, a selection of said first supplier from said list of suppliers;
generating, by said computing system, a second renewal request document associated with said at least one candidate, said second renewal request document comprising said portion of said candidate related data from said first renewal request document and said second input data, said second renewal request document for second renewing an association between said company and said at least one candidate; and
transmitting, by said computing system, said second renewal request document to said first supplier.

15. A computer program product, comprising a computer usable medium comprising an original request document for at least one candidate, a list of candidates, and a request/skills details template, and a computer readable program code embodied therein, said list of candidates comprising said at least one candidate, said computer readable program code adapted to implement a renewal method within a computing system, said method comprising:
receiving, by a computing system from a requester, a command for enabling a first renewal process associated with a company;
presenting, by said computing system, said first list of candidates to said requester;
receiving, by said computing system from said requester, a first selection of said at least one candidate of said list of candidates;
receiving, by said computing system from said requester, first verification data verifying that said at least one candidate is associated with said first renewal process;
generating, by said computing system, a first renewal request number for identifying a first renewal request document;
retrieving, by said computing system, a portion of candidate related data from said original request document;
placing, by said computing system, said portion of said candidate related data in said request/skills details template;
receiving, by said computing system from said requester, first input data associated with said at least one candidate;
placing, by said computing system, said first input data in said request/skills details template;
presenting, by said computing system, said request/skills details template comprising said portion of said candidate related data and said first input data;
receiving, by said computing system from said requester, first validation data verifying that said portion of said candidate related data from said original request document in said request/skills details template comprises first current data associated with said at least one candidate and said first renewal process;
receiving from said requester, by said computing system, a selection of a first supplier;
generating, by said computing system, a first renewal request document associated with said at least one candidate, said first renewal request document comprising said portion of said candidate related data from said original request document and said first input data, said first renewal request document for first renewing an association between said company and said at least one; and
transmitting, by said computing system, said first renewal request document to said first supplier.

16. The computer program product of claim 15, wherein said method further comprises:
configuring, by said computing system, said first renewal request document based on a country.

17. The computer program product of claim 15, wherein said method further comprises:
presenting, by said computing system for said requester, all of said candidate related data for review.

18. The computer program product of claim 15, wherein said first supplier is comprises a supplier selected from the group consisting of an original core supplier associated with said original request document and a non-core supplier.

19. The computer program product of claim 15, wherein said original request document comprises candidate skill selections for said at least one candidate, and wherein said first renewal request document comprises said first candidate skill selection for said first candidate.

20. The computer program product of claim 15, wherein said original request document comprises a first candidate skill selection for said at least one candidate, wherein said first renewal request document comprises a second candidate skill selection for said at least one candidate, and wherein said first candidate skill selection comprises a different candidate skill than said second candidate skill selection.

21. The computer program product of claim 15, wherein said method further comprises:
storing, within said computer usable medium, said first renewal request document;
receiving, by said computing system from said requester, a command for enabling a second renewal process associated with said company and said at least one candidate;
presenting, by said computing system, said first list of candidates to said requester;
receiving, by said computing system from said requester, a second selection of said at least one candidate of said list of candidates;
receiving, by said computing system from said requester, second verification data verifying that said at least one candidate is associated with said second renewal process;
generating, by said computing system, a second renewal request number for identifying a second renewal request document;
retrieving, by said computing system, a portion of candidate related data from said first renewal request document;
placing, by said computing system, said portion of said candidate related data from said first renewal request document in said request/skills details template;
receiving, by said computing system from said requester, second input data associated with said at least one candidate;
placing, by said computing system, said second input data in said request/skills details template;
presenting, by said computing system, said request/skills details template comprising said portion of said candidate related data from said first renewal request document and said second input data;
receiving, by said computing system from said requester, second validation data verifying that said portion of said candidate related data from said first renewal request document in said request/skills details template comprises second current data associated with said at least one candidate and said second renewal process;
receiving from said requester, by said computing system, a selection of said first supplier from said list of suppliers;
generating, by said computing system, a second renewal request document associated with said at least one candidate, said second renewal request document comprising said portion of said candidate related data from said first renewal request document and said second input data, said second renewal request document for second renewing an association between said company and said at least one candidate; and
transmitting, by said computing system, said second renewal request document to said first supplier.

22. A process for supporting computer infrastructure, said process comprising providing at least one support service for at least one of creating, integrating, hosting, maintaining, and deploying computer-readable code in a computing system comprising a memory unit, said memory unit comprising an original request document for at least one candidate, a list of candidates, and a request/skills details template, and a computer readable program code embodied therein, said list of candidates comprising said at least one candidate, said computer readable program code adapted to implement a renewal method within a computing system, said method comprising:
receiving, by a computing system from a requester, a command for enabling a first renewal process associated with a company;
presenting, by said computing system, said first list of candidates to said requester;
receiving, by said computing system from said requester, a first selection of said at least one candidate of said list of candidates;
receiving, by said computing system from said requester, first verification data verifying that said at least one candidate is associated with said first renewal process;
generating, by said computing system, a first renewal request number for identifying a first renewal request document;
retrieving, by said computing system, a portion of candidate related data from said original request document;
placing, by said computing system, said portion of said candidate related data in said request/skills details template;
receiving, by said computing system from said requester, first input data associated with said at least one candidate;
placing, by said computing system, said first input data in said request/skills details template;
presenting, by said computing system, said request/skills details template comprising said portion of said candidate related data and said first input data;
receiving, by said computing system from said requester, first validation data verifying that said portion of said candidate related data from said original request document in said request/skills details template comprises first current data associated with said at least one candidate and said first renewal process;
receiving from said requester, by said computing system, a selection of a first supplier;
generating, by said computing system, a first renewal request document associated with said at least one candidate, said first renewal request document comprising said portion of said candidate related data from said original request document and said first input data, said first renewal request document for first renewing an association between said company and said at least one; and
transmitting, by said computing system, said first renewal request document to said first supplier.

23. The process of claim 22, wherein said method further comprises:
configuring, by said computing system, said first renewal request document based on a country.

24. The process of claim 22, wherein said method further comprises:
presenting, by said computing system for said requester, all of said candidate related data for review.

25. The process of claim 22, wherein said first supplier is comprises a supplier selected from the group consisting of an original core supplier associated with said original request document and a non-core supplier.

26. The process of claim 22, wherein said original request document comprises candidate skill selections for said at least one candidate, and wherein said first renewal request document comprises said first candidate skill selection for said first candidate.

27. The process of claim 22, wherein said original request document comprises a first candidate skill selection for said at least one candidate, wherein said first renewal request document comprises a second candidate skill selection for said at least one candidate, and wherein said first candidate skill selection comprises a different candidate skill than said second candidate skill selection.

28. The process of claim 22, wherein said method further comprises:
storing, within said memory unit, said first renewal request document;
receiving, by said computing system from said requester, a command for enabling a second renewal process associated with said company and said at least one candidate;
presenting, by said computing system, said first list of candidates to said requester;
receiving, by said computing system from said requester, a second selection of said at least one candidate of said list of candidates;
receiving, by said computing system from said requester, second verification data verifying that said at least one candidate is associated with said second renewal process;
generating, by said computing system, a second renewal request number for identifying a second renewal request document;
retrieving, by said computing system, a portion of candidate related data from said first renewal request document;
placing, by said computing system, said portion of said candidate related data from said first renewal request document in said request/skills details template;
receiving, by said computing system from said requester, second input data associated with said at least one candidate;
placing, by said computing system, said second input data in said request/skills details template;
presenting, by said computing system, said request/skills details template comprising said portion of said candidate related data from said first renewal request document and said second input data;
receiving, by said computing system from said requester, second validation data verifying that said portion of said candidate related data from said first renewal request document in said request/skills details template comprises second current data associated with said at least one candidate and said second renewal process;
receiving from said requester, by said computing system, a selection of said first supplier from said list of suppliers;
generating, by said computing system, a second renewal request document associated with said at least one candidate, said second renewal request document comprising said portion of said candidate related data from said first renewal request document and said second input data, said second renewal request document for second renewing an association between said company and said at least one candidate; and
transmitting, by said computing system, said second renewal request document to said first supplier.
